(19) United States
(12) Patent Application Publication
(10) Pub. No.: US 2026/0086969 A1
(43) Pub. Date: Mar. 26, 2026

(54) BRIDGING FIELD BUS MODULE AND METHOD FOR OPERATING A BRIDGING FIELD BUS MODULE

(71) Applicant: Turck Holding GmbH, Halver (DE)

(72) Inventors: Benjamin Schelte, Hemer (DE); Marius Melnik, Hagen (DE); Christian Weustenfeld, Ennepetal (DE); Johannes vom Stein, Hückeswagen (DE)

(73) Assignee: Turck Holding GmbH, Halver (DE)

(21) Appl. No.: 19/401,455

(22) Filed: Nov. 26, 2025

Related U.S. Application Data
(63) Continuation of application No. PCT/EP2024/063971, filed on May 21, 2024.

(30) Foreign Application Priority Data
Jun. 2, 2023 (LU) LU504404

(51) Int. Cl. G06F 13/40

(52) U.S. Cl. CPC G06F 13/4027; G06F 2213/40

(57) ABSTRACT

A bridging field bus module designed for connecting two field bus networks to each other, comprising a coupling element, which is designed to detect a safety-relevant message received from the first field bus network on the field bus bridging module, wherein the bridging field bus module is designed to receive the safety-relevant message corresponding to the first safety protocol from the first field bus network, convert the detected safety-relevant message received from the first field bus network into a first and a second safety-relevant message, each corresponding to the second safety protocol, compare the first and second safety-relevant messages with each other, and output the first and/or second safety-relevant message to the second field bus network depending on a result of the comparison.

### CROSS REFERENCE TO RELATED APPLICATIONS

This application is a continuation application of international patent application PCT/EP2024/063971, filed on May 21, 2024, and designating the U.S., which claims priority to Luxembourg patent application LU504404, filed on June 2, 2023, each of which are hereby incorporated by reference in their entireties.

### TECHNICAL FIELD

The present disclosure is situated in the technical field of industrial automation.

The present disclosure can relate to a bridging field bus module, which is designed for connecting two networks to each other. The present disclosure can relate to a method for operating such a bridging field bus module. The present disclosure relates to a computer program and/or a computer-readable medium comprising commands which, when the program or commands are executed by a computer, cause said computer to execute the method at least in part.

### BACKGROUND

Moraes et al. (DE MORAES JOAO ET AL: “Architecture of an industrial analog input designed to meet safety requirements”, 2018 IEEE 19TH LATIN-AMERICAN TEST SYMPOSIUM (LATS), IEEE, 12. March 2018 (2018-03-12), pages 1-4, XP033335915, DOI: 10.1109/LATW.2018.8349673) describes an industrial analog input architecture that meets safety requirements.

DE 102020113572 A1 describes a protocol converter for converting safety-relevant messages between a first network and a second network. This comprises a single-channel interface device, which enables a message exchange with the first network and with the second network, wherein the first network has at least one first subscriber with a first safety communication layer, which processes a first safety communication protocol, and wherein the second network has at least one second subscriber with a second safety communication layer, which processes a second safety communication protocol. The protocol converter comprises a single-channel filter module device connected to the interface device for identifying messages with the first safety communication protocol and messages with the second safety communication protocol from messages received from the interface device, and an at least two-channel safety module connected to the filter-module device in order to convert messages identified by the filter-module device with the first safety communication protocol into messages with the second safety communication protocol or to convert messages identified by the filter-module device with the second safety communication protocol into messages with the first safety communication protocol.

### SUMMARY

A bridging field bus module is provided. The bridging field bus module is designed for connecting two field bus networks to each other, wherein a first field bus network of the two field bus networks uses a first safety protocol and a black channel principle for safety-relevant messages, and a second field bus network of the two field bus networks uses a second safety protocol, different from the first safety protocol, and the black channel principle for the safety-relevant messages. The bridging field bus module comprises a coupling element, which is designed to detect a safety-relevant message received from the first field bus network on the field bus bridging module. The bridging field bus module is designed to receive the safety-relevant message corresponding to the first safety protocol from the first field bus network. The bridging field bus module is designed to convert the detected safety-relevant message received from the first field bus network into a first and a second safety-relevant message, each corresponding to the second safety protocol. The bridging field bus module is designed to compare the first and second safety-relevant messages with each other. The bridging field bus module is designed to output at least one of the first and second safety-relevant messages to the second field bus network depending on a result of the comparison.

A method for operating a bridging field bus module is provided. The bridging field bus module is designed to connect two field bus networks to each other, wherein a first field bus network of the two field bus networks uses a first safety protocol and the black channel principle for safety-relevant messages, and a second field bus network of the two field bus networks uses a second safety protocol, different from the first safety protocol, and the black channel principle for the safety-relevant messages. The method comprises receiving a safety-relevant message, which corresponds to the first safety protocol, from the first field bus network on the bridging field bus module. The method comprises detecting the safety-relevant message received from the first field bus network on the field bus bridging module using a coupling element. The method comprises converting the detected safety-relevant message received from the first field bus network into a first and a second safety-relevant message, each corresponding to the second safety protocol. The method comprises comparing the first and second safety-relevant messages with each other. The method comprises outputting at least one of the first and second safety-relevant message to the second field bus network depending on a result of the comparison.

### DESCRIPTION OF THE DRAWINGS

In the drawings:

FIG. 1 schematically shows a network comprising two field bus networks which are connected to each other via a bridging field bus module according to the disclosure,

FIG. 2 schematically shows the bridging field bus module from FIG. 1 in detail and in isolation,

FIG. 3 schematically shows a flowchart of a disclosed method for operating the bridging field bus module from FIGS. 1 and 2 during conversion of a safety-relevant message from a first safety protocol into a second safety protocol,

FIG. 4 schematically shows a data format corresponding to a second safety protocol,

FIG. 5 schematically shows a flowchart of the disclosed method for operating the bridging field bus module from FIGS. 1 and 2 during conversion of a safety-relevant message from the second safety protocol into the first safety protocol, and

FIG. 6 schematically shows a flow diagram of a further disclosed method for operating the bridging field bus module from FIGS. 1 and 2.

### DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A bridging field bus module, which is designed to connect two field bus networks to each other, is provided.

A first field bus network of the two field bus networks uses a first safety protocol and the Black Channel principle for safety-relevant messages. A second field bus network of the two field bus networks uses a second safety protocol, different from the first safety protocol, as well as the black channel principle, for the safety-relevant messages.

The bridging field bus module comprises a coupling element, which is designed to detect a safety-relevant message received from the first field bus network on the field bus bridging module.

The bridging field bus module is designed to receive the safety-relevant message that corresponds to the first safety protocol from the first network.

The bridging field bus module is designed to convert the detected safety-relevant message received from the first field bus network into a first and a second safety-relevant message, each corresponding to the second safety protocol.

The bridging field bus module is designed to compare the first and second safety-relevant messages with each other.

The bridging field bus module is designed to output the first and/or the second safety-relevant message to the second field bus network depending on a result of the comparison, optionally only in case the first and second safety-relevant messages are identical.

The bridging field bus module can be designed to combine the first and second safety-relevant messages into a further message and output the further message to the second field bus network.

Where the term "network" is used in the following description, this can be understood to mean a "field bus network".

A field bus can be understood as a bus system that connects field devices, such as measurement probes or sensors and actuators, to an automation device or field bus module for the purpose of communication.

A field bus network can be understood as an interconnection of field bus modules over a bus that is designed as a field bus and uses the same safety protocol.

This means that subscribers of the two networks can be distinguished by their respective suitability for using the first or the second safety protocol. Because the bridging field bus module is designed to handle messages in the first and second safety protocols, it can be part of the first and second networks, thus creating a communicative connection or bridge between the two networks.

A safety protocol can be understood as a communication protocol for the transmission of (optionally predetermined) safety-relevant data or messages in automation applications. The safety protocol is therefore a special form of a communication protocol or bus protocol suitable for field bus systems.

The safety protocol can meet predetermined functional safety requirements, optionally a predetermined safety requirement level.

The safety requirement level is a term from the field of functional safety and is also referred to in the international standard IEC 61508/IEC61511 as a safety level or ‘safety integrity level’ (or SIL for short). The safety requirement level is used to assess electrical/electronic/programmable electronic (E/E/PE) systems regarding the reliability of safety functions. The desired level determines the safety-oriented design principles that must be adhered to minimize the risk of a malfunction.

It is conceivable that, in addition to the safety protocol, a bus protocol is implemented that does not satisfy the functional safety requirements. This bus protocol can be used as a means of communicating (optionally predefined) non-safety-relevant data, e.g. diagnostic data.

In the present case, the black channel principle will be used. The black channel principle is usually based on a communication channel or a bus protocol that does not meet the predefined requirements on functional safety. However, proof of compliance with relevant standards such as IEC 61508 may be required for the design of safety-oriented systems. If such systems use communication methods such as Ethernet for which this proof is not possible, the "black channel" principle can be used as an alternative. For this purpose, the safety protocol that is integrated between the safety application and the "non-safe" standard communication channel typically corresponds to the safety level of the safety-relevant system and detects and handles transmission errors of the underlying communication layers. This means that the "non-safe" transmission channel is continuously monitored for integrity by a higher-level "safe" protocol. In other words, with the "black channel" principle, an unsafe communication channel can be monitored by a safety protocol.

Examples of transmission errors at the level of the protocol packets in the "non-safe" channel include a repetition, a loss, an insertion, incorrect sequence, corruption, a delay and/or mixing of safe and non-safe telegrams.

If the safety protocol detects any of these errors, an error response can be initiated. It is conceivable that the (transmission) error can still be handled and thus tolerated, otherwise it is conceivable for the system to be transferred to a safe state, e.g. a standstill.

Safety-relevant field bus protocols or safety protocols are specified in the IEC 61158 (basic communication), IEC 61784-2 (real-time communication) and IEC 61784-3-18 (safety profile) standards.

The device(s) described herein can offer a number of advantages, which are explained in a non-limiting manner in the following.

There are several different safety protocols that are not compatible with each other (referred to above as the first and second safety protocols).

Individual safety-oriented digital signals can be exchanged between two incompatible safety protocols by outputting the data via safe outputs of one module and reading it in via safe inputs of another module.

However, this can be cumbersome because two modules are required, each making use of one of the two incompatible safety protocols, and every digital bit requires a safe output and a safe input.

Using a (optionally single) field bus module according to the disclosure, which serves as a bridge between two mutually incompatible safety protocols, i.e. a bridging field bus module, data can be safely exchanged between these two safety protocols, and optionally input and/or output data of the bridging field bus module. This is made possible, among other things, by the redundant conversion of the safety-relevant data (above as a message that exists in the first safety protocol). The redundant conversion allows any errors occurring during the conversion to be eliminated with a safety that meets the functional safety requirements described above.

Converting the safety-relevant message received from the first network into the first safety-relevant message may comprise forming a first checksum for the first safety-relevant message.

Converting the safety-relevant message received from the first network into the second safety-relevant message may comprise forming a second checksum for the second safety-relevant message.

The first safety-relevant message can be output to the second network together with the first checksum, depending on the result of the comparison.

In addition, the second safety-relevant message can be output to the second network together with the second checksum, depending on the result of the comparison.

It is conceivable that the first message forms a first subframe together with the first checksum and the second message forms a second subframe together with the second checksum, so that the first and the second subframe can be output to the second network in one message.

A checksum can mean a value that can be used to check the integrity of data, in this case the first or second message. The checksum can be calculated from the first or second message and can be in a form that is able to detect certain errors in the first or second message. Depending on how complex the checksum calculation rule is, multiple errors can be detected and optionally also corrected.

It is conceivable that the cyclic redundancy check will be applied. The CRC (cyclic redundancy check) is a procedure for determining a check value or checksum for data to detect errors in the transmission and/or storage of the data. Ideally, the procedure can even correct the received data independently to avoid a re-transmission. The cyclical redundancy check itself is known to the person skilled in the art and is therefore not further explained.

Transmitting the first and the second message together with their respective checksum in one message allows, on the one hand, a verification of error-free transmission of the two messages to a field bus module or to a receiver in the second network. On the other hand, however, the correctness of the conversion can also be checked by comparing the two checksums. This comparison of the two checksums can be carried out both by the field bus module of the network, i.e. by the receiver of the additional message, and, additionally or alternatively, by the bridging field bus module.

The bridging field bus module can comprise a first data processing device, which is designed to convert the safety-relevant message received from the first network into the first safety-relevant message and optionally to form the first checksum.

The first data processing device can be a microcontroller. A microcontroller (MCU) can be understood to mean a semiconductor chip comprising both a processor and peripheral functions. It is conceivable that the main memory and program memory is located partly or completely on the same chip. The microcontroller can be a single-chip computer system. For some microcontrollers, the term System-on-a-Chip (SoC) is therefore also used.

The first data processing device may comprise a first safe memory, which is designed to cache the first message and optionally buffer the first checksum.

A safe memory can be understood to mean a memory or a storage device that meets the same functional safety requirements as the first and/or the second safety protocol. By using a safe memory, the system as a whole can meet the functional safety requirements.

The bridging field bus module can comprise a second data processing device, which is designed to convert the safety-relevant message received from the first network into the second safety-relevant message and optionally to form the second checksum.

The first data processing device may comprise a second safe memory, which is designed to cache the second message and optionally buffer the second checksum.

The above description with reference to the first data processing device and to the first memory also applies mutatis mutandis to the second data processing device and the second memory.

Providing the second data processing device allows redundancy to be ensured. This has the advantage that an error occurring in either of the two data processing devices can be detected from a cross-comparison with a result of the other data processing device, which performs the same (safety) function. The two data processing devices can therefore check each other.

As described above, both field bus networks use the black channel principle.

The bridging field bus module further comprises the coupling element, which is designed to detect the safety-relevant message received at the field bus bridging module.

The coupling element can be designed to output the detected safety-relevant message to the first data processing device.

The coupling element can be designed to output the detected safety-relevant message to the second data processing device.

The coupling element can be implemented as a switch or gateway. The coupling element can be part of the black channel, which ends at the first or the second data processing device. The coupling element can therefore enable both safety-relevant and non-safety-relevant data to be communicated between the two field bus networks.

The above description can be summarized in other words and with reference to a possible implementation of the disclosure as described below, wherein the description that follows is not to be interpreted as limiting for the disclosure.

A bridging field bus module with two Ethernet ports can be provided, with a first Ethernet port being connected to a first network, on which a first safe bus protocol is implemented, and a second Ethernet port being connected to a second network, on which a second safe bus protocol is implemented that is incompatible with the first.

The bridging field bus module can have safe inputs and safe outputs.

The bridging field bus module can comprise two data memories for safety-relevant data, in which safety-relevant data is stored redundantly.

A checksum (CRC) can be generated from each set of safety-relevant data. The checksums of the first data memory and the second data memory can be compared with each other to check the validity of the data and to check the correspondence of the data of the two memory areas.

One of the safe bus protocols can be a commercially available safety protocol (e.g. Profi Safe, CIPP Safety) for which compatible controllers, actuators and sensors and other network subscribers from different manufacturers are available on the market. The other safe bus protocol can have the following characteristics: the safety-relevant information can be in a redundant form (for example, in two parts with the same information content), each part may be secured with a checksum that checks the validity of this part, and/or it can be a non-commercially available safe bus protocol for which only "dedicated" safe network subscribers are provided (although the structure and safety mechanisms of the protocol are known, e.g. Open Safety).

At least one of the two memories can have three memory areas, wherein a first of the memory areas is provided for a first of the two safety protocols, a second memory area is provided for a second of the two safety protocols and a third memory area is provided for safe input and/or output data which is received from sensors and/or actuators directly connected to the bridging field bus module.

The disclosure can further relate to a method for operating a bridging field bus module which is designed for connecting two field bus networks to each other.

A first field bus network of the two field bus networks uses a first safety protocol and the black channel principle for safety-relevant messages. A second field bus network of the two field bus networks uses a second safety protocol, different from the first safety protocol, as well as the black channel principle, for the safety-relevant messages.

The method comprises receiving a safety-relevant message, which corresponds to the first safety protocol, from the first field bus network on the bridging field bus module.

The method comprises detecting the safety-relevant message received from the first field bus network on the field bus bridging module using a coupling element.

The method comprises converting the detected safety-relevant message received from the first field bus network into a first and a second safety-relevant message, each corresponding to the second safety protocol.

The method comprises comparing the first and second safety-relevant messages with each other.

The method comprises outputting the first and/or second safety-relevant message to the second network depending on a result of the comparison.

The method can comprise combining the first and second safety-relevant messages into a further message and outputting the further message to the second network.

The method can also be referred to as a control method for a bridging field bus module.

The method can be a computer-implemented method, i.e. one, multiple or all steps of the method can be carried out at least in part by a computer or data processing device, optionally the bridging field bus module device described above.

The description above with reference to the bridging field bus module also applies mutatis mutandis to the method and vice versa.

Furthermore, a computer program is provided comprising commands which, when the program is executed by a computer, cause the computer to execute or carry out at least in part the method described above.

A program code of the computer program can be written in any coding language, optionally a coding language suitable for field bus module controllers.

The description above with reference to the bridging field bus module and to the method also applies mutatis mutandis to the computer program, and vice versa.

Furthermore, a (non-transitory) computer-readable medium, optionally a computer-readable storage medium, is provided. The computer-readable medium comprises commands which, when the commands are executed by a computer, cause the computer to execute or carry out at least in part the method described above.

This means that a computer-readable medium can be provided that comprises a computer program defined above. The computer-readable medium can be any digital data storage device, such as a USB stick, a hard disk, a CD-ROM, an SD card or an SSD card (or an SSD drive/SSD hard disk).

The computer program does not necessarily have to be stored on such a computer-readable storage medium to be made available to the bridging field bus module, but can also be obtained via the Internet or other external means.

The above reference to the bridging field bus module, the method and the computer program also applies mutatis mutandis to the computer-readable medium and vice versa.

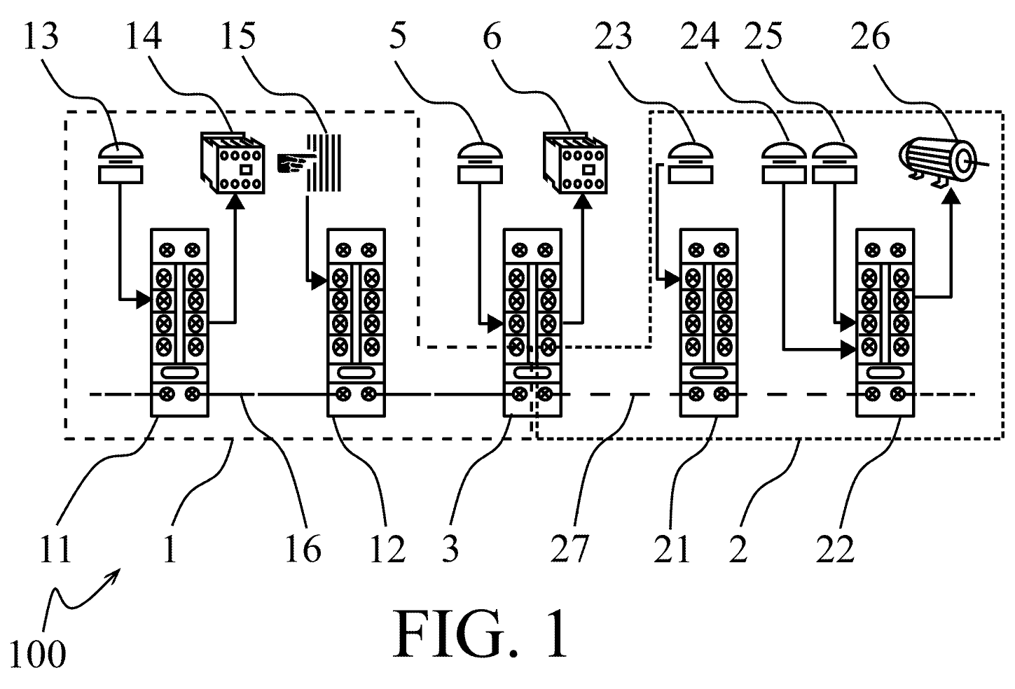

The network 100 shown in FIG. 1 also comprises two field bus networks 1, 2.

The first of the two field bus networks 1 is described in detail below.

The first of the two field bus networks 1 comprises two field bus modules 11, 12, an emergency stop switch 13, a relay 14 and a light barrier 15. The two field bus modules 11, 12 are connected to each other via a first field bus 16. The emergency stop switch 13 is connected to a safe input of the first field bus module 11. The relay 14 is connected to a safe output of the first field bus module 11. The light barrier 15 is connected to a safe input of the second field bus module 12.

The first field bus network 1 uses a bus protocol with a first safety protocol for communication via the field bus 16. The black channel principle is used. This means that the safety protocol used, which is designed to ensure correct transmission of safety-relevant data from a transmitter to a receiver, is independent of the bit transmission layer (physical layer) and/or the bus protocol. It is conceivable, for example, that Industrial Ethernet is used as the bit transmission layer (physical layer) or bus protocol, which is based on the Profi Safe safety protocol. Both field bus modules 11, 12 of the first field bus network 1 are designed to communicate safety-relevant data or information via the field bus 16 using Profi Safe, i.e. both to receive and output.

It is conceivable that on the first field bus module 11 a message (in the form of a simple digital signal) is received from the actuated emergency stop switch 13 and then a message acting as a control signal (also in the form of a simple digital signal) is output from the first field bus module 11 to the relay 14, so that the relay 14 switches to a desired state. It is also conceivable that on the first field bus module 11 a message in the first safety protocol is received from the triggered light barrier 15 via the second field bus module 15 and then the message acting as a control signal (as a simple digital signal) is output to the relay 14 from the first field bus module 11, so that the relay 14 switches to the desired state.

The second of the two field bus networks 2 is described in detail below.

The second of the two field bus networks 2 also comprises two field bus modules 21, 22, as well as three emergency stop switches 23, 24, 25 and an actuator 26. The two field bus modules 21, 22 are connected to each other via a second field bus 27. A first of the three emergency stop switches, hereinafter referred to as the second emergency stop switch 23, is connected to a safe input of the first field bus module 21. A second and a third of the three emergency stop switches, hereinafter referred to as the third and fourth emergency stop switch 23, 24, are each connected to a safe input of the second field bus module 22. The actuator 26, e.g. a motor, is connected to a safe output of the second field bus module 22.

The second field bus network 2 uses a bus protocol with a second safety protocol for communication via the field bus 27. The black channel principle is also used in this case. This means that the second safety protocol used, which is designed to ensure correct transmission of safety-relevant data from a transmitter to a receiver, is independent of the bit transmission layer (physical layer) and/or the bus protocol. It is conceivable, for example, that Industrial Ethernet is again used as the bit transmission layer (physical layer) or bus protocol, which is based on the Open Safety protocol. Both field bus modules 21, 22 of the second field bus network 2 are designed to communicate safety-relevant data or information via the field bus 27 using Open Safety, i.e. both to receive and output.

It is conceivable that on the second field bus module 22 a message in the second safety protocol is received from the actuated second emergency stop switch 23 via the first field bus module 21 and then a message acting as a control signal is output to the actuator 26 from the second field bus module 22, so that the actuator 26 switches to a desired state (e.g. is switched off). It is also conceivable that at the second field bus module 22 a message is received from the actuated third and/or fourth emergency stop switch 24, 25 and then the message acting as a control signal is output to the actuator 26 from the second field bus module 22, so that the actuator 26 switches to the desired state.

In all the cases described above, however, communication only takes place within the first or within the second field bus network 1, 2.

However, it is also conceivable that the following case must be represented by the network 100.

A safe state is defined such that both the relay 14 of the first field bus network 1 and the actuator 26 of the second field bus network 2 are at zero voltage or are transferred to a desired state. This should be initiated whenever one of the emergency stop switches 13, 23, 24, 25 and/or the light barrier 15 is actuated or triggered.

A logic running in a program in a single one of the field bus modules 11, 12, 21, 22 of the two networks 1, 2 performs a safety function for this purpose. All safety-relevant data of the two field bus networks 1, 2 must therefore be made available to the logic.

For example, if the logic is only executed in the first field bus module 11 of the first field bus network 1, the safety-relevant data of the three emergency stop switches 23, 24, 25 of the second field bus network 2 must also be available in the first field bus network 1, so that the first field bus module 11 of the first field bus network 1 can access it or receive this data. The same applies to safety-relevant data for actuator 26 of the second field bus network 2, which is generated by the logic and output by the first field bus module 11 of the first field bus network 1. This safety-relevant data must be available in the second field bus network 2 for the second field bus module 22 of this field bus network 2, so that a corresponding control signal, again as safety-relevant data, can be output from the second field bus module 22 of the second field bus network 2 to the actuator 26.

However, this is challenging if, as is the case here, the first and second safety protocols, in which or according to which the safety-relevant data are communicated are not compatible with each other, i.e. if the safety-relevant data of the first field bus network 1 cannot be read directly in the second field bus network 2 and vice versa.

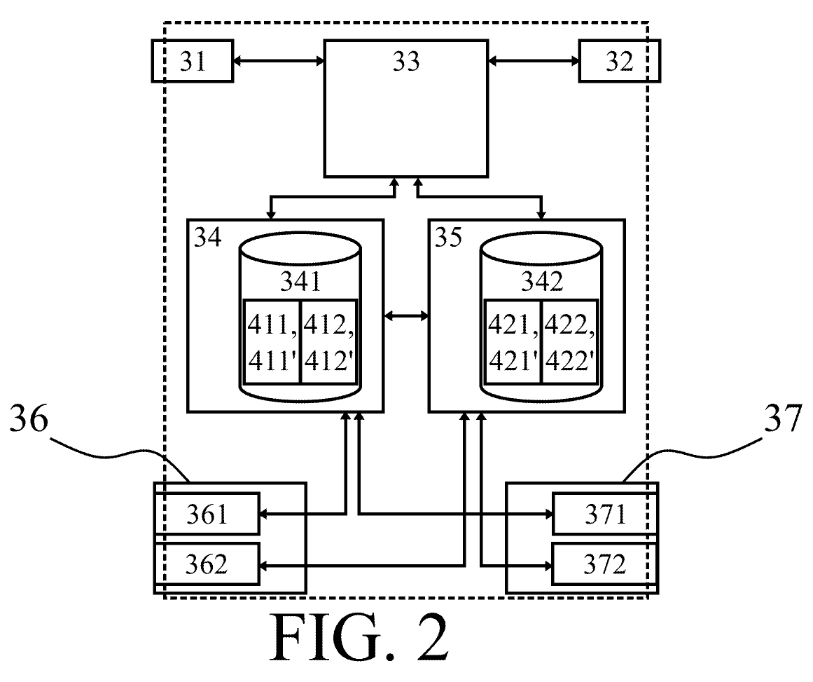

For this reason, part of the network 100 is a disclosed bridging field bus module 3, which connects the two field bus networks 1, 2 to each other or with each other. The bridging field bus module 3 is designed to receive safety-relevant data in both safety protocols, to buffer this safety-relevant data, to translate it into the respective other safety protocol and output it to the respective other field bus network 1, 2. For this purpose, the bridging field bus module 3 is connected to both field buses 16, 27. In the following, the bridging field bus module 3 is described in further detail, also with reference to FIG. 2.

The bridging field bus module 3 comprises a first port 31 for connecting to the field bus 16 of the first of the two field bus networks 1, on which the bus protocol with the first safety protocol is implemented.

The bridging field bus module 3 comprises a second port 32 for connecting to the field bus 27 of the second of the field bus networks 2, on which the bus protocol with the second safety protocol, incompatible with the first, is implemented.

The bridging field bus module 3 comprises a coupling element 33 connected to each of the first and second ports 31, 32, which comprises an unsafe memory and acts as a switch.

The bridging field bus module 3 comprises a first data processing device 34 connected to the coupling element 33 and having a first safe memory 341.

The bridging field bus module 3 comprises a second data processing device 35 connected to the coupling element 33 and having a second safe memory 351.

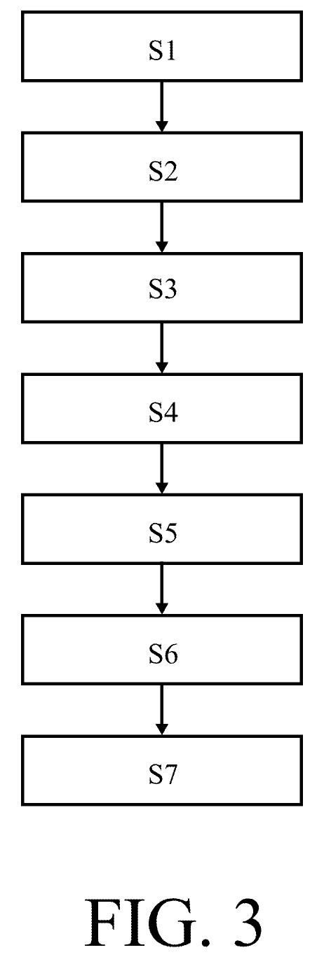

The operation of the bridging field bus module 3 is described in detail below, also with reference to FIG. 3, which shows a flow diagram of the method for operating the bridging field bus module 3.

In a first step S1 of the method, a message in the first safety protocol received by the first field bus network 1 via the first port 31 is detected by the coupling element 33.

In a second step S2 of the method, the message detected in the first step S1 is output by the coupling element 33 to both the first and the second data processing device 34, 35.

The coupling element 33 is part of the black channel, whereas the two data processing devices 34, 35 are no longer part of the black channel. Processing of the safety-relevant data or messages can thus take place in the two data processing devices 34, 35.

In a third step S3 of the method, both the first and the second data processing device 34, 35 are each used to perform a conversion of the message in the first safety protocol received from the coupling element 33 into a message 411, 421 corresponding thereto in the second safety protocol (i.e. a conversion into a message which corresponds to the structure specified in the second safety protocol). This is achieved by forming a first checksum 412 in the first data processing device 34 and by forming a second checksum 422 in the second data processing device 35, which are formed in each case over the first or second message 411, 421 in the second safety protocol.

In a fourth step S4 of the method, the message 411 generated by the first data processing device 34 is stored in the first memory 341 as a first message in the second safety protocol. The first memory may have a separate memory area for this purpose. In the fourth step S4 of the method, the message 421 generated by the second data processing device 35 is also stored in the second memory 351 as a second message in the second safety protocol. The second memory 351 may have a separate memory area for this purpose. Both messages 411, 421 are saved with their associated checksum 412, 422, i.e. the first message 411 in the second safety protocol with the first checksum 412 and the second message 421 in the second safety protocol with the second checksum 422.

The safety-relevant message in the first safety protocol is therefore redundantly converted, secured with a checksum 412, 422 and saved.

In a fifth step S5 of the method, a comparison is made of the two messages 411, 421, that is, the first message 411 in the second safety protocol and, respectively, with the second message 421 in the second safety protocol, and/or of their associated checksums 412, 422. The comparison can be carried out by one or both data processing devices 34, 35. If the comparison shows that the two messages 411, 421 and/or their checksums 412, 422 are identical, the method continues with a sixth step S6. Otherwise, a further, optional attempt can be made to convert the message from the first into the second safety protocol, to try to correct one of the two messages (optionally if there are only minor differences), and/or the method can be terminated.

In a sixth step S6 of the method, the first message 411 in the second safety protocol, which message is stored in the first memory 341, and the second message 421 in the second safety protocol which is stored in the second memory 351, can be combined, in each case together with their checksum 412, 422, by the first and/or the second data processing device 34, 35 to form a message 4 and read by the coupling element or coupler 33.

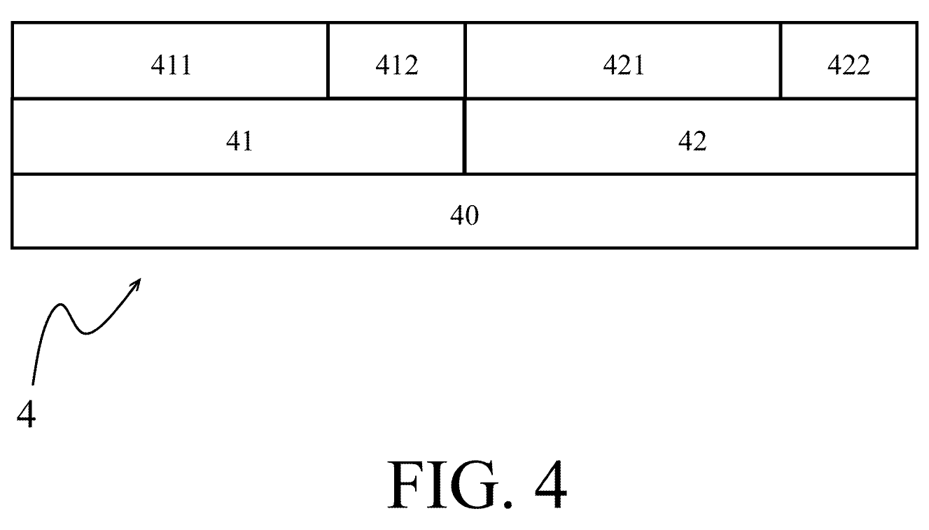

A structure of such a message 4 is illustrated in FIG. 4. The message 4 in the second safety protocol comprises two subframes 41, 42, which together form a safety frame 40, wherein one of the two subframes 41 comprises the first message 411 in the second safety protocol together with the first checksum 412 from the first memory 341, and the other of the two subframes 42 comprises the second message 421 in the second safety protocol together with the second checksum 422 from the second memory 342.

Alternatively, only the first or the second message 411, 421 together with their respective checksum 412, 422 can be used to form the message 4. For this purpose, the respective message 411, 421 together with its checksum 412, 422 can be provided twice in the message 4. The first or the second message 411, 421 together with its respective checksum 412, 422 then forms the respective subframe 41, 42 of the safety frame 40 of the message 4.

In a seventh step S7 of the method the message 4 received in the sixth step S6 is output from the coupler 33 via the second port 32 to the second field bus network 2, more precisely its field bus 27.

This makes it possible, in the case described above, to transfer safety-relevant data from the first field bus network 1 to the second field bus network 2.

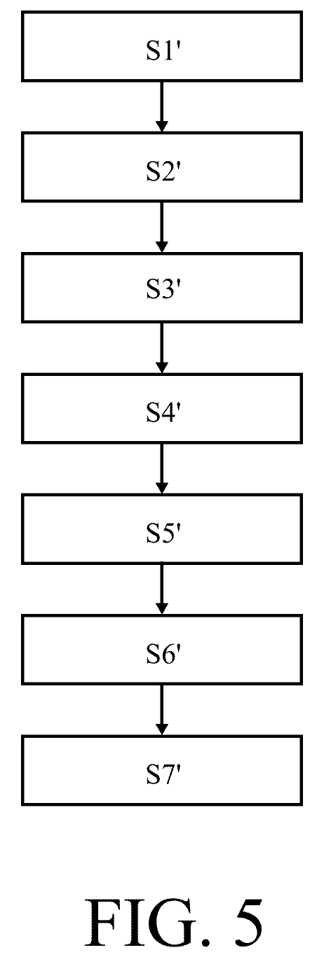

In the use case described above, a safety-relevant message in the first safety protocol is converted into a message in the second safety protocol. The case described above is analogous to the case in which a safety-relevant message in the second safety protocol is converted into a message in the first safety protocol. This is described in detail below with reference to FIG. 5 and with reference to FIGS. 1 to 4, with only the differences with respect to the above case being indicated. FIG. 5 shows a flow diagram of the method for the case in which the message is converted from the second safety protocol into the first safety protocol, wherein the steps of the method corresponding to the steps described above and messages are labelled with the same reference sign and the suffix "‘".

In a first step S1‘ of the method, a message 4 in the second safety protocol received by the second field bus network 2 via the second port 32 is detected by the coupling element 33 (analogous to the first step S1 described above).

In a second step S2‘ of the method, the message 4 detected in the first step S1‘ is output by the coupling element 33 to both the first and the second data processing device 34, 35 (analogous to the second step S2 described above).

In a third step S3‘ of the method (analogous to the third step S3 described above), both the first and the second data processing device 34, 35 are each used to perform a conversion of the message 4 in the second safety protocol received from the coupling element 33 into a message 411‘, 421‘ corresponding thereto in the first safety protocol (i.e. a conversion into a message which corresponds to the structure specified in the first safety protocol). This is achieved by forming a first checksum 412‘ in the first data processing device 34 and by forming a second checksum 422‘ in the second data processing device 35, which are formed in each case over the first and second message 411‘, 421‘ in the second safety protocol.

In a fourth step S4‘ of the method (which is analogous to the fourth step S4 of the method described above), the message 411‘ generated by the first data processing device 34 is stored in the first memory 341 as a first message in the first safety protocol. The first memory 341 may have a separate memory area for this purpose. In the fourth step S4‘ of the method, the message 421‘ generated by the second data processing device 35 is also stored in the second memory 351 as a second message in the second safety protocol. The second memory 351 may have a separate memory area for this purpose. Both messages 411‘, 421‘ are saved with their associated checksum 412‘, 422‘, i.e. the first message 411‘ in the first safety protocol with the first checksum 412‘ and the second message 421‘ in the first safety protocol with the second checksum 422‘.

The safety-relevant message 4 in the second safety protocol is therefore redundantly converted, secured with a checksum 412‘, 422‘ and saved.

In a fifth step S5‘ of the method (which is analogous to the fifth step S5 of the method described above), a comparison of the two messages 411, 421 is performed, i.e. of the first message 411‘ in the first safety protocol and, respectively, with the second message 421‘ in the first safety protocol, and/or their associated checksums 412‘, 422‘. The comparison can be carried out by one or both data processing devices 34, 35. If the comparison shows that the two messages 411‘, 421‘ and/or their checksums 412‘, 422‘ are identical, the method continues with a sixth step S6‘. Otherwise, a further, optional attempt can be made to convert the message from the first into the second safety protocol, to try to correct one of the two messages (optionally if there are only minor differences), and/or the method can be terminated.

In a sixth step S6‘ of the method, the first message 411‘ in the first safety protocol, which message is stored in the first memory 341, and the second message 421‘ in the second safety protocol, which is stored in the second memory 351, can be read, in each case together with their checksums 412‘, 422‘, by the coupling element or coupler 33. A structure of such a message according to or in the first safety protocol corresponds to one of the subframes 41, 42 of the message 4 shown in FIG. 4.

In a seventh step S7‘ of the method, the message received in the sixth step S6‘, which is in the first safety protocol, is output by the coupler 33 via the first port 31 to the second field bus network 1, more precisely its field bus 16.

This makes it possible, in the case described above, to transfer safety-relevant data from the second field bus network 2 to the first field bus network 1.

In the following, an additional or alternative implementation of the network 100, and optionally of the bridging field bus module 3, is described in detail.

In this implementation, the network 100 has a fifth emergency stop switch 5 and a second relay 6. The fifth emergency stop switch 5 is connected to a safe input 36 of the bridging field bus module 3, wherein the safe input 36 in turn has two terminals 361, 362, so that redundant cabling is provided. The second relay 6 is connected to a safe output of the field bus bridging module 37, wherein the safe output 37 in turn has two terminals 371, 372, so that redundant cabling is provided. Therefore, each message comprising safety-relevant data is received from the fifth emergency stop switch 25 at both terminals 361, 362 of the safe input 36 and each message comprising safety-relevant data is output via both terminals 371, 372 of the safe output 37. The description of the safe input and output of the bridging field bus module 3 also applies mutatis mutandis to the above-mentioned safe inputs and outputs of the field bus modules 11, 12, 21, 22 of the first and the second field bus network 1, 2.

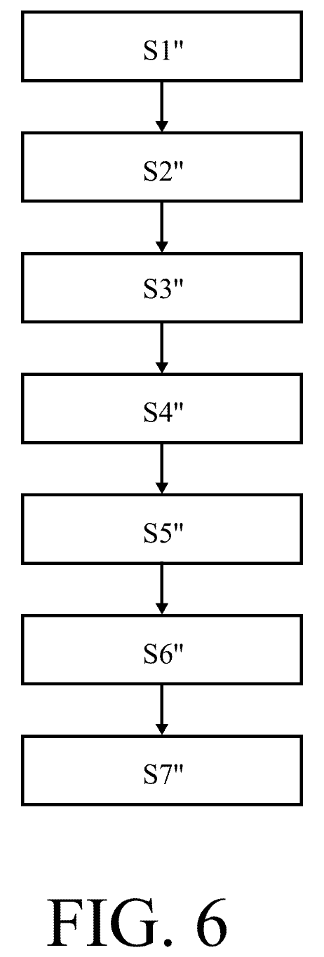

The fifth emergency stop switch 5 and the second relay 6 do not use a safety protocol to communicate with the bridging field bus module 3. The data is communicated as a (simple or redundant) digital signal (optionally without using a safety protocol) from the fifth emergency stop switch 5 to the bridging field bus module and output from the latter as a (simple) digital signal to the second relay. However, it is conceivable that when the fifth emergency stop switch 5 is actuated, the actuator 26 of the second field bus network 2 must be stopped. Therefore, the safety-relevant data received from the fifth emergency stop switch 5 in the first bridging module 3 must also be made available to the second field bus network in the second safety protocol. The same applies to the first safety protocol if, for example, safety-relevant data is to be communicated from the fifth emergency stop switch 5 to the first field bus module 11 of the first field bus network 1. Therefore, essentially the above-described method, with a modification in the first step S1 or S1‘ and the second step S2 or S2‘, as described in detail below, is also used here. A flow diagram of this modified method is shown in FIG. 6. The steps of the method corresponding to the steps described above are marked with the same reference symbol and the suffix "‘‘".

In a first step S1‘‘ of the modified method, one and the same message is received from the fifth emergency stop switch 5 at both terminals 361, 362 of the safe input 36.

In a second step S2‘‘ of the modified method, the message received in the first step S1‘‘ of the modified method by the first terminal 361 of the safe input 36 is output to the first data processing device 34 of the bridging field bus module 3 and the message received in the first step S1‘‘ of the modified method by the second terminal 362 of the safe input 36 is output to the second data processing device 35 of the bridging field bus module 3.

In a third step S3‘‘ of the modified method, both the first and second data processing devices 34, 35 are each used to convert the message received in the first safety protocol from the first or second terminal 361, 362 into a corresponding message 411, 421 in the second (and/or the first) safety protocol. This is achieved by forming a first checksum 412 (or 412‘) in the first data processing device 34 and by forming a second checksum 422 (or 422‘) in the second data processing device 35, which are formed in each case over the first or second message 411, 421 (or 411‘, 412‘) in the second (respectively the first) safety protocol. The third step S3‘‘ of the modified method corresponds to the third step S3 of the method described above with reference to FIG. 3 (or to the third step S3‘ of the method described above with reference to FIG. 5).

In a fourth step S4‘‘ of the modified method, the message 411 (or 411‘) generated by the first data processing device 34 is stored in the first memory 341 as a first message in the second (respectively first) safety protocol. The first memory 341 may have a separate memory area for this purpose. Furthermore, in a fourth step S4‘‘ of the modified method, the message 421 (or 421‘) generated by the second data processing device 35 is stored in the second memory 351 as a second message in the second (respectively first) safety protocol. The second memory 351 may have a separate memory area for this purpose. Both messages 411, 421 (or 411‘, 421‘) are saved with their corresponding checksum 412, 422 (or 412‘, 422‘), i.e. the first message 411 in the second (respectively first) safety protocol with the first checksum 412 (or 412‘) and the second message 421 (or 421‘) in the second (respectively first) safety protocol with the second checksum 422 (or 422‘).

The message received via the safe input 36 is therefore redundantly converted into the second (or the first) safety protocol, secured with a checksum 412, 422 (or 412‘, 422‘) and saved. The fourth step S4‘ of the modified method corresponds to the fourth step S4 of the method described above with reference to FIG. 3 (respectively to the fourth step S4‘ of the method described above with reference to FIG. 5).

In a sixth step S6‘ of the modified method, the first message 411 in the second safety protocol, which message is stored in the first memory 341, and the second message 421 in the second safety protocol, which is stored in the second memory 351, are combined, in each case together with their checksum 412, 422, to form a message 4 and read by the coupler 33.

A structure of such a message 4 is illustrated in FIG. 4. The message 4 in the second safety protocol comprises two subframes 41, 42, which together form a safety frame 40, wherein one of the two subframes 41 comprises the first message 411 in the second safety protocol together with the first checksum 412 from the first memory 341, and the other of the two subframes 42 comprises the second message 421 in the second safety protocol together with the second checksum 422 from the second memory 342.

When the message is converted into the message in the first safety protocol, the first message 411‘ in the first safety protocol, which message is stored in the first memory 341, or the second message 421‘ in the second safety protocol, which is stored in the second memory 351, can be read, in each case together with their checksum 412‘, 422‘, by the coupling element or coupler 33. A structure of such a message according to or in the first safety protocol corresponds to one of the subframes 41, 42 of the message 4 shown in FIG. 4.

The sixth step S6‘ of the modified method corresponds to the sixth step S6 of the method described above with reference to FIG. 3 (respectively to the sixth step S6‘ of the method described above with reference to FIG. 5).

In a seventh step S7‘ of the modified method the message 4 received in the sixth step S6‘‘ of the modified method is output from the coupler 33 via the second port 32 to the second (respectively first) field bus network 2 (respectively 1), more precisely its field bus 27 (respectively 16). The seventh step S7‘‘ of the modified method corresponds to the seventh step S7 of the method described above with reference to FIG. 3 (respectively to the seventh step S7‘ of the method described above with reference to FIG. 5).

### LIST OF REFERENCE CHARACTERS

1 first field bus network

11 first field bus module

12 second field bus module

13 first emergency stop or emergency shutoff switch

14 first relay

15 light barrier

16 field bus

2 second field bus network

21 first field bus module

22 second field bus module

23 second emergency stop or emergency shutoff switch

24 third emergency stop or emergency shutoff switch

25 fourth emergency stop or emergency shutoff switch

26 actuator

27 field bus

3 bridging field bus module

31 first port

32 second port

33 coupling element

34 first data processing device

341 first safe memory

35 second data processing device

351 second safe memory

36 safe input

361 first connection

362 second connection

37 safe output

371 first terminal

371 second terminal

4 message according to a second safety protocol

40

frame

41 first subframe

411 first message according to a second safety protocol

412 first checksum

42 second subframe

421 second message according to second safety protocol

422 second checksum

411‘ first message according to first safety protocol

412‘ first checksum

421‘ second message according to first safety protocol

422‘ second checksum

5 fourth emergency stop or emergency shutoff switch

6 second relay

100 network

S1-S7, S1‘ – S7‘, S1‘‘-S7‘‘ steps of the (modified) method

What is claimed is:

1. A bridging field bus module designed for connecting two field bus networks to each other, wherein a first field bus network of the two field bus networks uses a first safety protocol and a black channel principle for safety-relevant messages, and a second field bus network of the two field bus networks uses a second safety protocol, different from the first safety protocol, and the black channel principle for the safety-relevant messages, the bridging field bus module comprising:
a coupling element, which is designed to detect a safety-relevant message received from the first field bus network on the field bus bridging module,
wherein the bridging field bus module is designed to receive the safety-relevant message corresponding to the first safety protocol from the first field bus network, convert the detected safety-relevant message received from the first field bus network into a first and a second safety-relevant message, each corresponding to the second safety protocol, compare the first and second safety-relevant messages with each other, and output at least one of the first and second safety-relevant message to the second field bus network depending on a result of the comparison.

2. The bridging field bus module according to claim 1, wherein:
the conversion of the safety-relevant message received from the first field bus network into the first safety-relevant message includes forming a first checksum for the first safety-relevant message,
the conversion of the safety-relevant message received from the first field bus network into the second safety-relevant message includes forming a second checksum for the second safety-relevant message, and
the first safety-relevant message together with the first checksum are output to the second field bus network depending on the result of the comparison.

3. The bridging field bus module according to claim 2, wherein the second safety-relevant message is output together with the second checksum to the second field bus network depending on the result of the comparison.

4. The bridging field bus module according to claim 1, wherein the bridging field bus module comprises a first data processing device, designed to convert the safety-relevant message received from the first field bus network into the first safety-relevant message.

5. The bridging field bus module according to claim 2, wherein the bridging field bus module comprises a first data processing device, designed to convert the safety-relevant message received from the first field bus network into the first safety-relevant message, and to form the first checksum.

6. The bridging field bus module according to claim 4, wherein the coupling element is designed to output the detected safety-relevant message to the first data processing device.

7. The bridging field bus module according to claim 4, wherein the first data processing device comprises a first safe memory, which is designed to buffer the first safety-relevant message.

8. The bridging field bus module according to claim 1, wherein the bridging field bus module comprises a second data processing device designed to convert the safety-relevant message received from the first field bus network into the second safety-relevant message.

9. The bridging field bus module according to claim 2, wherein the bridging field bus module comprises a second data processing device designed to convert the safety-relevant message received from the first field bus network into the second safety-relevant message and to form the first checksum.

10. The bridging field bus module according to claim 8, wherein the coupling element is designed to output the detected safety-relevant message to the second data processing device.

11. The bridging field bus module according to claim 8, wherein the second data processing device comprises a second safe memory designed to buffer the second safety-relevant message.

12. A method for operating a bridging field bus module designed to connect two field bus networks to each other, wherein a first field bus network of the two field bus networks uses a first safety protocol and the black channel principle for safety-relevant messages, and a second field bus network of the two field bus networks uses a second safety protocol, different from the first safety protocol, and the black channel principle for the safety-relevant messages, the method comprising:
receiving a safety-relevant message, which corresponds to the first safety protocol, from the first field bus network on the bridging field bus module,
detecting the safety-relevant message received from the first field bus network on the field bus bridging module using a coupling element,
converting the detected safety-relevant message received from the first field bus network into a first and a second safety-relevant message, each corresponding to the second safety protocol,
comparing the first and second safety-relevant messages with each other, and
outputting at least one of the first and second safety-relevant message to the second field bus network depending on a result of the comparison.

13. A non-transitory computer-readable medium comprising commands which, when the commands are executed by a bridging field bus module, which is designed to connect two field bus networks to each other and comprises a coupling element, cause said module to carry out the method as claimed in claim 12.
